(19) United States
(12) Patent Application Publication
(10) Pub. No.: US 2022/0004043 A1
(43) Pub. Date: Jan. 6, 2022

(54) ARRAY SUBSTRATE

(71) Applicant: TCL China Star Optoelectronics Technology Co., Ltd., Shenzhen (CN)

(72) Inventor: Lixuan CHEN, Shenzhen (CN)

(73) Assignee: TCL China Star Optoelectronics Technology Co., Ltd., Shenzhen (CN)

(21) Appl. No.: 16/625,794

(22) PCT Filed: Nov. 28, 2019
(86) PCT No.: PCT/CN2019/121556

§ 371 Date: Dec. 23, 2019

(30) Foreign Application Priority Data
Nov. 13, 2019 (CN) 201911109286.6

(51) Int. Cl. G02F 1/1343

(52) U.S. Cl. CPC G02F 1/13439

(57) ABSTRACT

An array substrate is provided, wherein the array substrate includes a substrate, a plurality of positive electrodes and a plurality of negative electrodes all disposed on the substrate, wherein the plurality of positive electrodes each connected end to end have a closed circular structure, and a vertical projection of each of the positive electrodes projected on the substrate surrounds a vertical projection of a corresponding negative electrode projected on the substrate.

### BACKGROUND

### Field of Invention

The present disclosure relates to the field of display technology, and more particularly to an array substrate.

### Description of the Prior Art

Liquid crystal displays are widely used, and the rationale is: liquid crystals are a special substance with a state between solid and liquid. Liquid crystals are an organic compound under normal circumstances. However, a molecular arrangement of liquid crystals are as regular as that of solid crystals. Therefore, they are called liquid crystals. Another special property of liquid crystals is that the molecular arrangement will change when liquid crystals are applied with an electric field. At the same time the liquid crystals can prevent lights from passing through (lights can pass through when no electric field is applied to liquid crystals) when given with a polarizer. An amount of light transmission of a certain color can be changed if a color filter is applied and a change of voltages applied to the liquid crystals. Specifically, changing the voltage applied to the liquid crystals can change the amount of light transmission thereof.

In the prior art, the liquid crystals and other medium are deflected by a horizontal electric field to control emergent light intensity and control shading effects in present in-plane switching (IPS) and fringe field switching (FFS) type liquid crystal displays. In a new display device, driving methods like FFS and IPS structure to drive horizontal electrodes are also mostly used to generate a horizontal electric field and different driving voltages are used to control a strength of the horizontal electric field. In horizontal electrode designs, the strength and a uniformity of the horizontal electric field thereof is a very important factor because the electric field is used to control a deflection of the medium between two electrodes.

However, a present electric field provided by the horizontal electrode is uneven, resulting in poor display quality. Therefore, the prior art has defects and urgently needs improvement.

### SUMMARY

A technical problem solved according to the array substrate of the present disclosure is an electric field provided by a horizontal electrode is uneven resulting in display quality.

The present disclosure provides an array substrate, including:

a substrate; and

a plurality of positive electrodes and a plurality of negative electrodes, disposed on the substrate;

wherein the plurality of positive electrodes each connected end to end have a closed circular structure, and a vertical projection of each of the positive electrodes projected on the substrate surrounds a vertical projection of a corresponding negative electrodes projected on the substrate;

wherein both an outer contour shape and an inner contour shape of each of the positive electrodes are same as a shape of a corresponding negative electrode; and

wherein a distance between the vertical projection of each of the positive electrodes projected on the substrate and the vertical projection of the corresponding negative electrode projected on the substrate ranges from 4.5 um to 5.5 um.

According to the array substrate of the present disclosure, each of the positive electrodes is disposed coaxially with the corresponding negative electrode.

According to the array substrate of the present disclosure, the plurality of positive electrodes comprise an annular shape, and the plurality of negative electrodes comprise a circular block shape.

According to the array substrate of the present disclosure, both the outer contour and the inner contour of the plurality of positive electrodes have an N-regular-polygon shape, and the plurality of negative electrodes have an N-regular-polygon shape.

According to the array substrate of the present disclosure, N sides of each of the positive electrodes are corresponding and parallel to N sides of the corresponding negative electrode.

According to the array substrate of the present disclosure, a first insulating layer is disposed on the substrate, and both the plurality of positive electrodes and the plurality of negative electrodes are disposed on the first insulating layer and disposed on a same layer.

According to the array substrate of the present disclosure, a second insulating layer is disposed on the first insulating layer, the plurality of negative electrodes are disposed between the first insulating layer and the second insulating layer, and the plurality of positive electrodes are disposed on an upper surface of the second insulating layer.

According to the array substrate of the present disclosure, the distance between the vertical projection of each of the positive electrodes projected on the substrate and the vertical projection of the corresponding negative electrode projected on the substrate is 5.0 um.

The present disclosure also provides an array substrate, including:

a substrate; and

a plurality of positive electrodes and a plurality of negative electrodes, disposed on the substrate;

wherein the plurality of positive electrodes each connected end to end have a closed circular structure, and a vertical projection of each of the positive electrodes projected on the substrate surrounds a vertical projection of a corresponding negative electrodes projected on the substrate.

According to the array substrate of the present disclosure, both an outer contour shape and an inner contour shape of each of the positive electrodes are same as a shape of a corresponding negative electrode.

According to the array substrate of the present disclosure, each of the positive electrodes is disposed coaxially with the corresponding negative electrodes.

According to the array substrate of the present disclosure, the plurality of positive electrodes comprise an annular shape, and the plurality of negative electrodes comprise a circular block shape.

According to the array substrate of the present disclosure, both the outer contour and the inner contour of the plurality of positive electrodes have an N-regular-polygon shape, and the plurality of negative electrodes have an N-regular-polygon shape.

According to the array substrate of the present disclosure, N sides of each of the positive electrodes are corresponding and parallel to N sides of the corresponding negative electrode.

According to the array substrate of the present disclosure, a first insulating layer is disposed on the substrate, and both the plurality of positive electrodes and the plurality of negative electrodes are disposed on the first insulating layer and disposed on a same layer.

According to the array substrate of the present disclosure, a second insulating layer is disposed on the first insulating layer, the plurality of negative electrodes are disposed between the first insulating layer and the second insulating layer, and the plurality of positive electrodes are disposed on an upper surface of the second insulating layer.

According to the array substrate of the present disclosure, a distance between the vertical projection of each of the positive electrodes projected on the substrate and the vertical projection of the corresponding negative electrode projected on the substrate ranges from 4.5 um to 5.5 um.

According to the array substrate of the present disclosure, the distance between the vertical projection of each of the positive electrodes projected on the substrate and the vertical projection of the corresponding negative electrode projected on the substrate is 5.0 um.

According to the array substrate of the present disclosure, the plurality of positive electrodes are disposed in a closed circular pattern and disposed around the corresponding negative electrode, improving a uniformity of a horizontal electric field and improving the display quality.

### BRIEF DESCRIPTION OF DRAWINGS

In order to more clearly illustrate technical solutions of the embodiments or in the prior art, accompany drawings which need to be used in the description of the embodiments or the prior art will be simply introduced. Obviously, the accompany drawings in the following description are merely some embodiments, and for those of ordinary skill in the art, other embodiments can further be obtained according to these accompany drawings without contributing any creative work.

FIG. 1 is a top view structural diagram of an array substrate according to the present disclosure.

FIG. 2 is a sectional view structural diagram of the array substrate according to the present disclosure.

FIG. 3 is another sectional view structural diagram of the array substrate according to the present disclosure.

FIG. 4 is another top view structural diagram of the array substrate according to the present disclosure.

### DETAILED DESCRIPTION OF PREFERRED EMBODIMENTS

The embodiments of the present application are described in detail below, and the examples of the embodiments are illustrated in the drawings, wherein the same or similar reference numerals are used to refer to the same or similar elements or elements having the same or similar functions. The embodiments described below with reference to the accompanying drawings are intended to be illustrative, and are not to be construed as limiting.

In the description of the present application, it is to be understood that the terms “center”, “longitudinal”, “transverse”, “length”, “width”, “thickness”, “upper”, “lower”, “front”, “post”, “left”, “right”, “vertical”, “horizontal”, “top”, “bottom”, “inside”, “outside”, “clockwise”, “counterclockwise”, etc. refer to positional relationship based on the orientational or positional relationship shown in the drawings, and are merely for the convenience of describing the present application and the simplified description, and do not indicate or imply that the device or component referred to has a specific orientation, and is constructed and operated in a specific orientation. Therefore, it should not be construed as limiting the application. Moreover, the terms “first” and “second” are used for descriptive purposes only and are not to be construed as indicating or implying a relative importance or implicitly indicating the number of technical feature s indicated. Thus, features defining “first” or “second” may include one or more of the described features either explicitly or implicitly. In the description of the present application, the meaning of “plurality” is two or more, unless specifically defined otherwise.

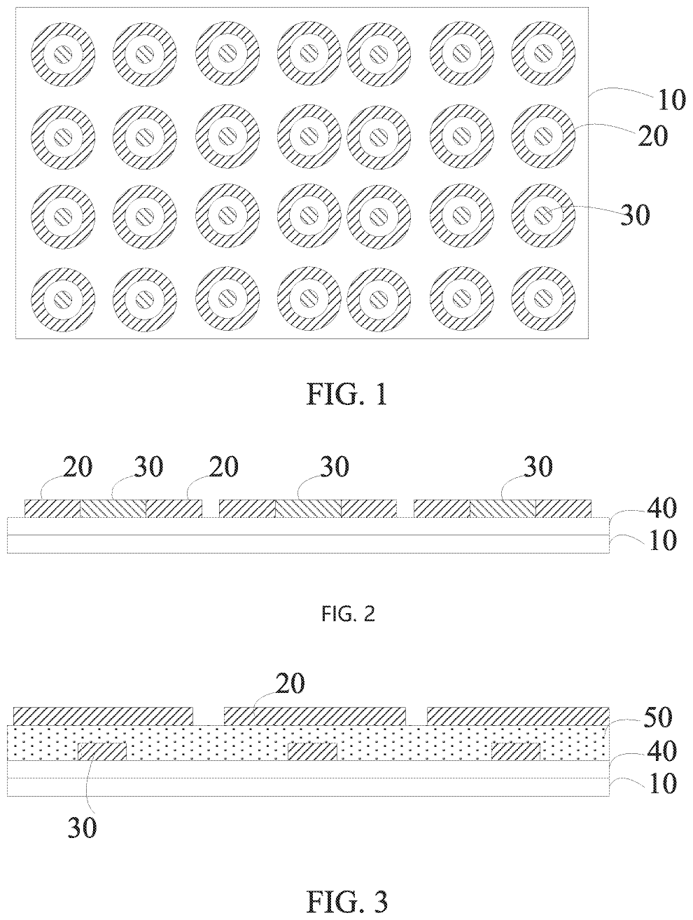

Please refer to FIG. 1, FIG. 1 is a top view structural diagram of an array substrate according to the present disclosure. As shown in FIG. 1, the array substrate comprises a substrate 10 and a plurality of positive electrodes 20 and a plurality of negative electrodes 30 disposed on the substrate 10. The plurality of positive electrodes 20 each connected end to end have a closed circular structure. A vertical projection of each of the positive electrodes 20 projected on the substrate surrounds a vertical projection of a corresponding negative electrode 30 projected on the substrate 10.

Of course, it can be understood that other metal layers, semiconductor layers and insulating layers can be also disposed on the substrate 10 of the array substrate to generate a thin-film transistor array layer, corresponding scan lines, and corresponding data lines. However, improvements of the present disclosure are only about electrodes, and therefore, the thin-film transistor array layer is not described too much.

According to some disclosures, both an outer contour shape and an inner contour shape of each of the positive electrodes 20 are same as a shape of a corresponding negative electrodes 30. For example, both the outer contour shape and the inner contour shape of each of the positive electrodes 20 can be circular or regular polygons. Further, each of the positive electrodes 20 is disposed coaxially with the corresponding negative electrodes 30.

According to the present disclosure, the plurality of positive electrodes 20 comprise an annular shape, and the plurality of negative electrodes 30 comprise a circular block shape. According to some disclosures, a distance between the vertical projection of each of the positive electrodes 20 projected on the substrate 10 and the vertical projection of the corresponding negative electrode 30 projected on the substrate 10 ranges from 4.5 um to 5.5 um. Preferably, the distance between the vertical projection of each of the positive electrodes 20 projected on the substrate 10 and the vertical projection of the corresponding negative electrode 30 projected on the substrate 10 is 5.0 um. The plurality of positive electrodes and the plurality of negative electrodes each can be made of transparent conducting metals such as indium tin oxides.

Please refer to FIG. 2 at the same time, FIG. 2 is a sectional view structural diagram of the array substrate according to the present disclosure. According to present disclosure, a first insulating layer 40 is disposed on the substrate 10, and both the plurality of positive electrodes 20 and the plurality of negative electrodes 30 are disposed on the first insulating layer 40 and disposed on a same layer. The plurality of positive electrodes 20 and the plurality of negative electrodes 30 are generated by a single mask.

Of course, please refer to FIG. 3, FIG. 3 is another sectional view structural diagram of the array substrate according to the present disclosure. According to the present disclosure, a second insulating layer 50 is disposed on the first insulating layer 40. The plurality of negative electrodes 30 are disposed between the first insulating layer 40 and the second insulating layer 50. The plurality of positive electrodes 20 are disposed on an upper surface of the second insulating layer 50. The first insulating layer 40 and the second insulating layer 50 can be generated by depositing silicon nitride or silicon dioxide. It should be noted that a layer where the plurality of negative electrodes are located and a layer where the plurality of positive electrodes are located can be exchanged, which is not limited here.

According to the array substrate of the present disclosure, the plurality of positive electrodes are designed to be annular, and the plurality of negative electrodes are designed to be circular block shaped. An electric field between the plurality of positive electrodes and the plurality of negative electrodes tends to be uniform and stable, improving a display quality.

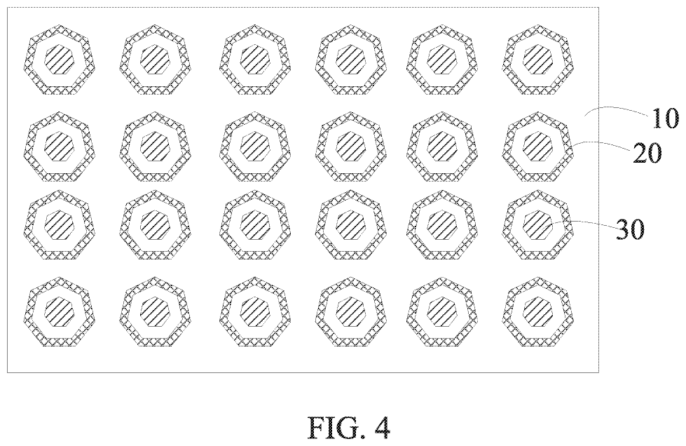

According to some disclosures, please refer to FIG. 4, FIG. 4 is another top view structural diagram of the array substrate according to the present disclosure. As shown in FIG. 4, both the outer contour and the inner contour of the plurality of positive electrodes 20 have an N-regular-polygon shape, and the plurality of negative electrodes 30 have an N-regular-polygon shape. For example, a regular hexagon, a regular heptagon, or the like. N sides of each of the positive electrodes 20 are corresponding and parallel to N sides of the corresponding negative electrode 30.

According to the present disclosure, in order to prevent a display defect problem caused by an obvious abnormal field of a horizontal electric field between the positive electrodes and negative electrodes, which is not limited to the field of liquid crystal displays (LCDs) but also occurs in the field of nanoparticle luminescence and organic luminescence, each of the plurality of positive electrodes is disposed in a closed circular pattern and disposed around the corresponding negative electrode, thereby improving a uniformity of a horizontal electric field and improving the display quality.

According to the array substrate of the present disclosure, each of the plurality of positive electrodes is disposed in a closed circular pattern and disposed around the corresponding negative electrode, thereby improving a uniformity of a horizontal electric field and improving the display quality.

The present disclosure is described in detail in accordance with the above contents with the specific preferred examples. However, this present disclosure is not limited to the specific examples. For a person of ordinary skill in the art, on the premise of keeping the conception of the present disclosure, the technical personnel can also make simple deductions or replacements, all of which should be considered to belong to the protection scope of the present disclosure.

What is claimed is:

1. An array substrate, comprising:
a substrate; and
a plurality of positive electrodes and a plurality of negative electrodes disposed on the substrate;
wherein the plurality of positive electrodes each connected end to end have a closed circular structure, and a vertical projection of each of the positive electrodes projected on the substrate surrounds a vertical projection of a corresponding negative electrode projected on the substrate;
wherein both an outer contour shape and an inner contour shape of each of the positive electrodes are same as a shape of a corresponding negative electrode; and
wherein a distance between the vertical projection of each of the positive electrodes projected on the substrate and the vertical projection of the corresponding negative electrode projected on the substrate ranges from 4.5 um to 5.5 um.

2. The array substrate as claimed in claim 1, wherein each of the positive electrodes is disposed coaxially with the corresponding negative electrode.

3. The array substrate as claimed in claim 2, wherein the plurality of positive electrodes comprise an annular shape, and the plurality of negative electrodes comprise a circular block shape.

4. The array substrate as claimed in claim 2, wherein both the outer contour and the inner contour of the plurality of positive electrodes have an N-regular-polygon shape, and the plurality of negative electrodes have an N-regular-polygon shape.

5. The array substrate as claimed in claim 4, wherein N sides of each of the positive electrodes are corresponding and parallel to N sides of the corresponding negative electrode.

6. The array substrate as claimed in claim 1, wherein a first insulating layer is disposed on the substrate, and both the plurality of positive electrodes and the plurality of negative electrodes are disposed on the first insulating layer and disposed on a same layer.

7. The array substrate as claimed in claim 6, wherein a second insulating layer is disposed on the first insulating layer, the plurality of negative electrodes are disposed between the first insulating layer and the second insulating layer, and the plurality of positive electrodes are disposed on an upper surface of the second insulating layer.

8. The array substrate as claimed in claim 1, wherein the distance between the vertical projection of each of the positive electrodes projected on the substrate and the vertical projection of the corresponding negative electrode projected on the substrate is 5.0 um.

9. An array substrate, comprising:
a substrate; and
a plurality of positive electrodes and a plurality of negative electrodes disposed on the substrate;
wherein the plurality of positive electrodes each connected end to end have a closed circular structure, and a vertical projection of each of the positive electrodes projected on the substrate surrounds a vertical projection of a corresponding negative electrode projected on the substrate.

10. The array substrate as claimed in claim 9, wherein both an outer contour shape and an inner contour shape of each of the positive electrodes are same as a shape of a corresponding negative electrode.

11. The array substrate as claimed in claim 10, wherein each of the positive electrodes is disposed coaxially with the corresponding negative electrodes.

12. The array substrate as claimed in claim 11, wherein the plurality of positive electrodes comprise an annular shape, and the plurality of negative electrodes comprise a circular block shape.

13. The array substrate as claimed in claim 11, wherein both the outer contour and the inner contour of the plurality of positive electrodes have an N-regular-polygon shape, and the plurality of negative electrodes have an N-regular-polygon shape.

14. The array substrate as claimed in claim 11, wherein N sides of each of the positive electrodes are corresponding and parallel to N sides of the corresponding negative electrode.

15. The array substrate as claimed in claim 9, wherein a first insulating layer is disposed on the substrate, and both the plurality of positive electrodes and the plurality of negative electrodes are disposed on the first insulating layer and disposed on a same layer.

16. The array substrate as claimed in claim 15, wherein a second insulating layer is disposed on the first insulating layer, the plurality of negative electrodes are disposed between the first insulating layer and the second insulating layer, and the plurality of positive electrodes are disposed on an upper surface of the second insulating layer.

17. The array substrate as claimed in claim 9, wherein a distance between the vertical projection of each of the positive electrodes projected on the substrate and the vertical projection of the corresponding negative electrode projected on the substrate ranges from 4.5 um to 5.5 um.

18. The array substrate as claimed in claim 17, wherein the distance between the vertical projection of each of the positive electrodes projected on the substrate and the vertical projection of the corresponding negative electrode projected on the substrate is 5.0 um.
